(19) United States
(12) Patent Application Publication
(10) Pub. No.: US 2014/0358579 A1
(43) Pub. Date: Dec. 4, 2014

(54) CLINICAL DECISION SUPPORT SYSTEM FOR QUALITY EVALUATION AND IMPROVEMENT OF DISCHARGE PLANNING

(71) Applicant: KONINKLIJKE PHILIPS N.V., EINDHOVEN (NL)

(72) Inventors: Mariana Nikolova-Simons, Bolton, MA (US); Hans-Aloys Wischmann, Henstedt-Ulzburg (DE); Johan Muskens, Hurwenen (NL); Joseph Ernest Rock, Littleton, MA (US)

(21) Appl. No.: 14/362,754

(22) PCT Filed: Nov. 23, 2012
(86) PCT No.: PCT/IB2012/056654

§ 371 Date: Jun. 4, 2014

Related U.S. Application Data
(60) Provisional application No. 61/568,677, filed on Dec. 9, 2011.

(51) Int. Cl. G06F 19/00

(52) U.S. Cl. CPC G06F 19/3431; G06F 19/325
USPC 705/2

(57) ABSTRACT

A system and method for evaluating a discharge planning process. The system and method perform the steps of determining whether a current set of discharge criteria matches current clinical practices, generating a matched set of discharge criteria by adapting the current set of discharge criteria to reflect the current clinical practices, generating a matching quality indicator value indicating a level of matching between the current set of discharge criteria and the current clinical practices, determining whether a user adheres to the matched set of discharge criteria, generating an adherence quality indicator value indicating a level to which the user adheres to the matched set of discharge criteria, determining whether the matched set of discharge criteria satisfies a target outcome and generating a satisfaction quality indicator value indicating a level to which the matched set of discharge criteria satisfies the target outcome.

Discharge planning is a difficult process for physicians and hospital professionals. Discharge planning may be especially complicated for patients suffering from certain diseases and/or conditions. For example, managing a patient suffering from acute decompensated heart failure (ADHF) can be complex because of the different etiology and many co-morbidities such as renal dysfunction, COPD, hypertension, diabetes, sleep apnea, etc. Discharge planning and proactive therapy optimization for an individual patient have recently been developed using a set of patient specific discharge planning criteria. However, current discharge planning systems and methods do not evaluate health economic aspects related to discharge planning for a patient population, which may be used to improve the discharge planning process.

A method for evaluating a discharge planning process. The method including determining whether a current set of discharge criteria matches current clinical practices, generating a matched set of discharge criteria by adapting the current set of discharge criteria to reflect the current clinical practices, generating a matching quality indicator value indicating a level of matching between the current set of discharge criteria and the current clinical practices, determining whether a user adheres to the matched set of discharge criteria, generating an adherence quality indicator value indicating a level to which the user adheres to the matched set of discharge criteria, determining whether the matched set of discharge criteria satisfies a target outcome and generating a satisfaction quality indicator value indicating a level to which the matched set of discharge criteria satisfies the target outcome.

A system for evaluating a quality of a threshold process. The system having a memory storing a current set of discharge criteria and a processor determining whether the current set of discharge criteria matches current clinical practices, generating a matched set of discharge criteria by matching the current set of discharge criteria to reflect the current clinical practices, generating a matching quality indicator value indicating a level of matching between the current set of discharge criteria and the current clinical practices, determining whether a user adheres to the matched set of discharge criteria, generating an adherence quality indicator value indicating a level to which the user adheres to the matched set of discharge criteria, determining whether the matched set of discharge criteria satisfies a target outcome, and generating a satisfaction quality indicator value indicating a level to which the matched set of discharge criteria satisfies the target outcome, using the processor.

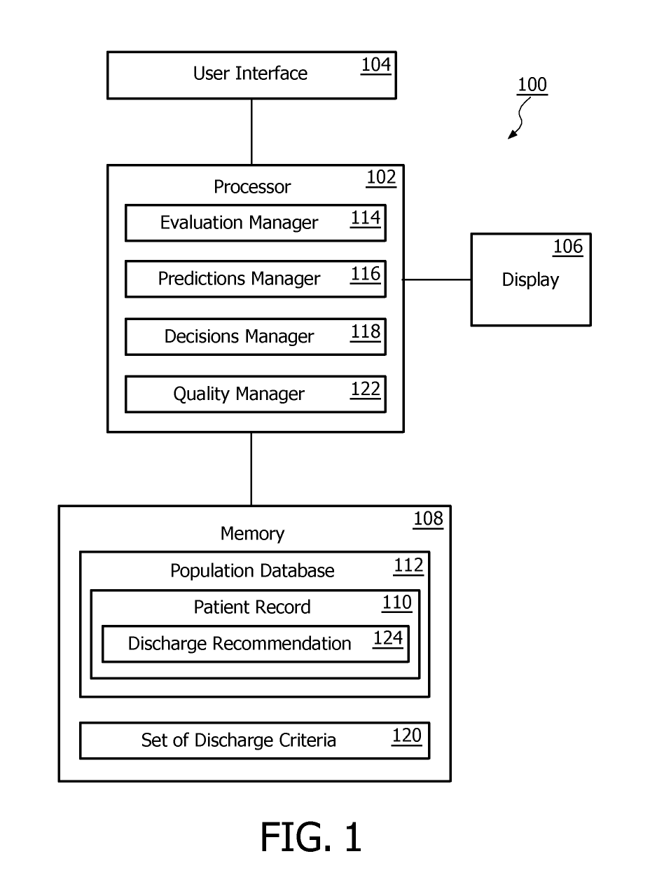

FIG. 1 shows a schematic drawing of a system according to an exemplary embodiment.

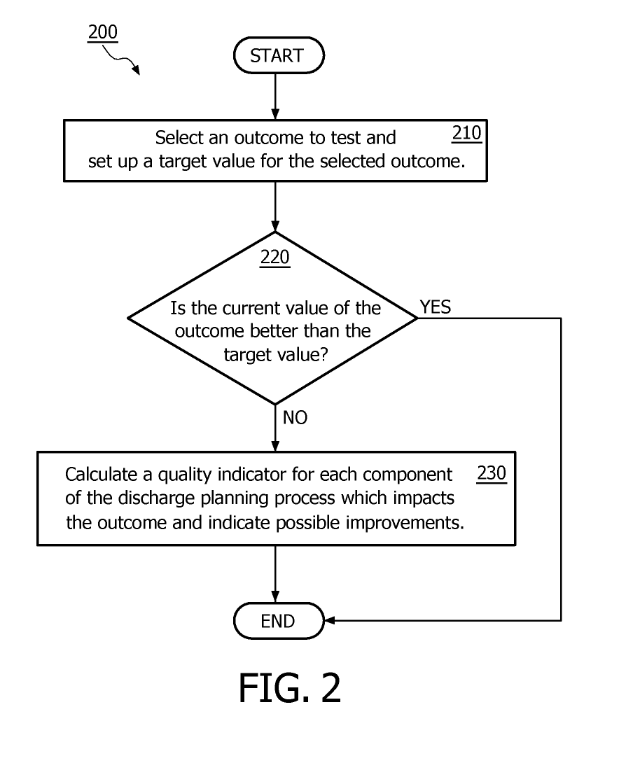

FIG. 2 shows a flow diagram of a method for evaluating a selected outcome against a target value according to an exemplary embodiment.

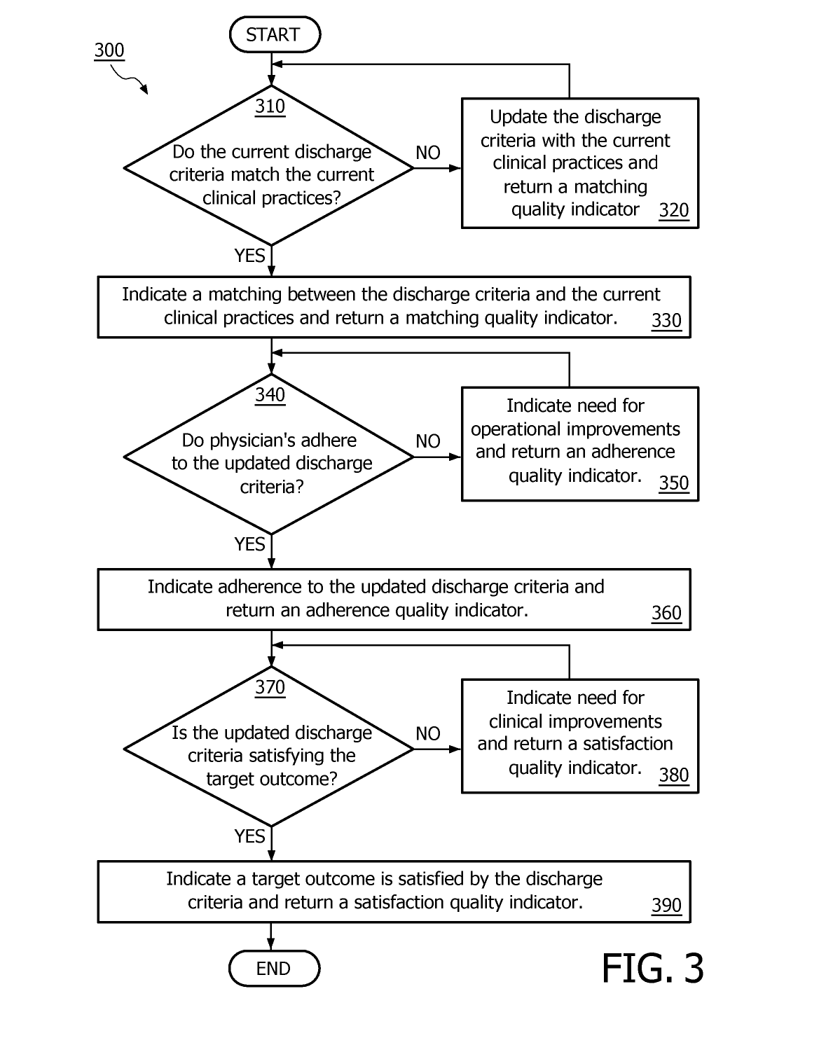

FIG. 3 shows a flow diagram of a method for evaluating the quality of a set of discharge criteria and indicating a need for quality improvement according to an exemplary embodiment.

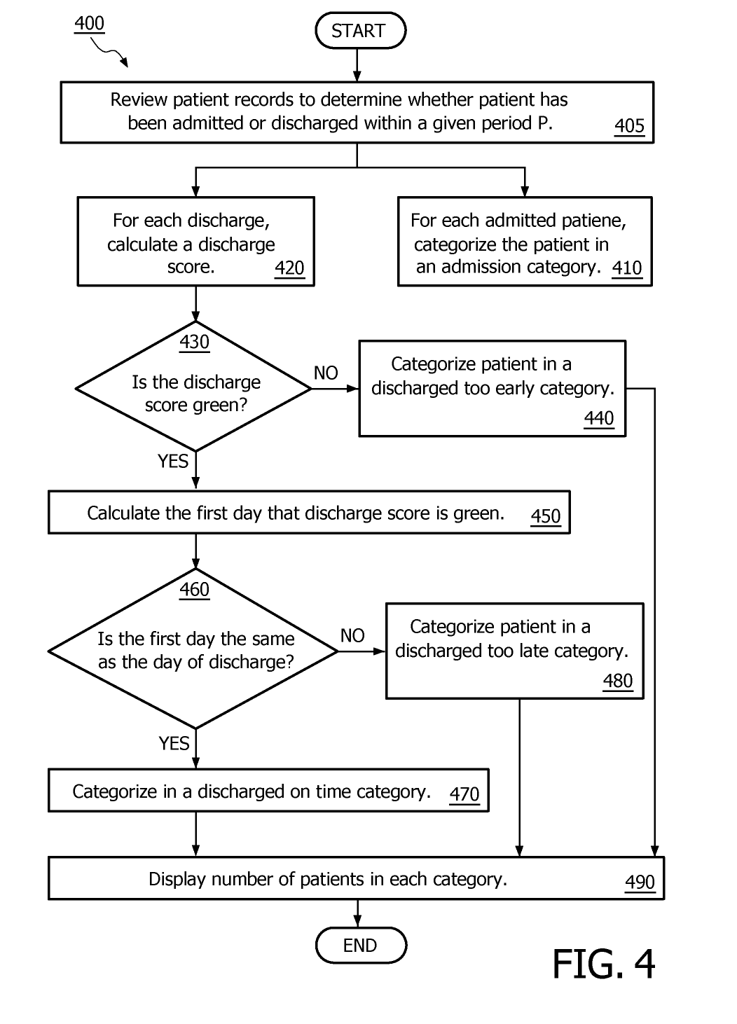

FIG. 4 shows a flow diagram of a method for determining a patient population distribution during a predetermined period according to an exemplary embodiment.

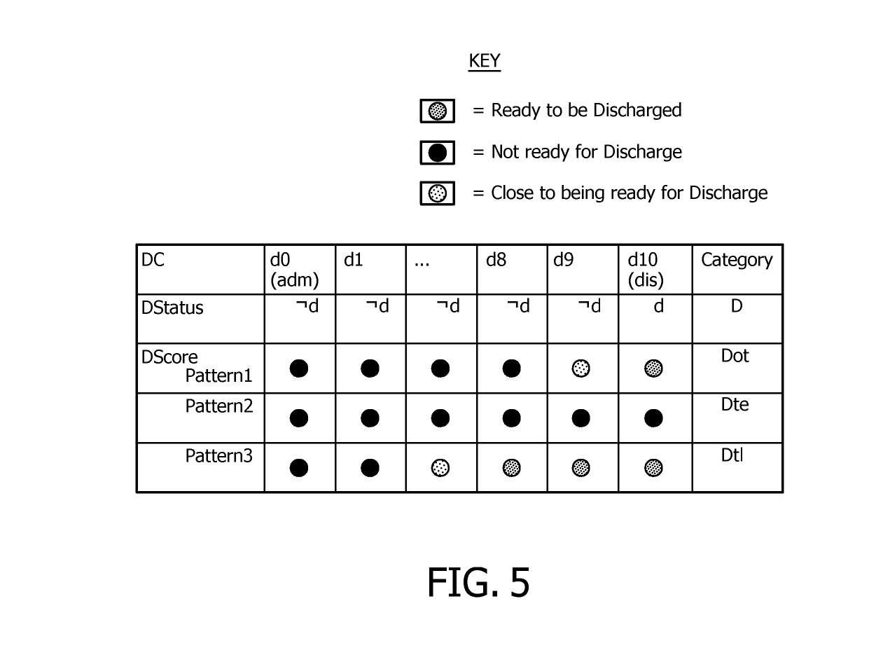

FIG. 5 shows a table of potential patterns of discharge scores which indicate a category of discharge according to an exemplary embodiment.

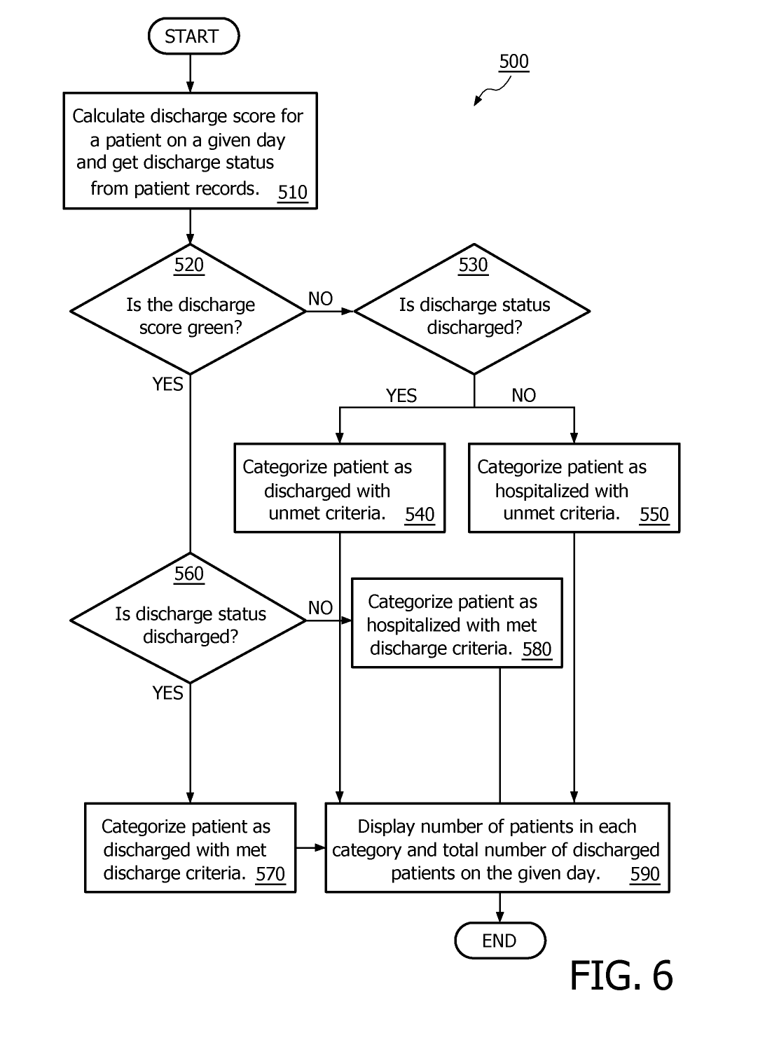

FIG. 6 shows a flow diagram of a method for determining a patient population distribution on a given day according to an exemplary embodiment.

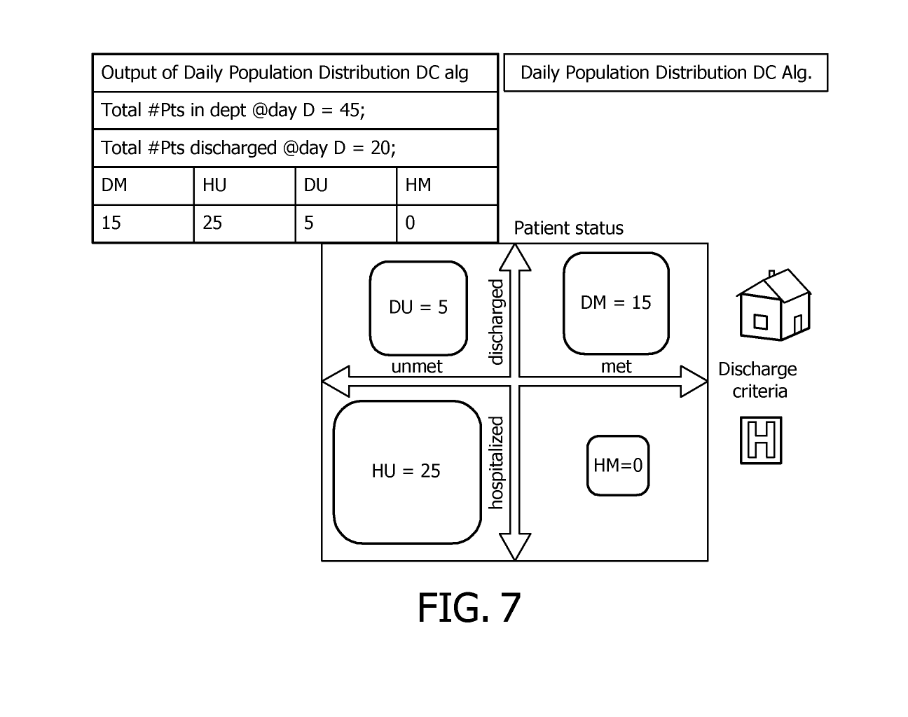

FIG. 7 shows an output displayed according to the method of FIG. 6.

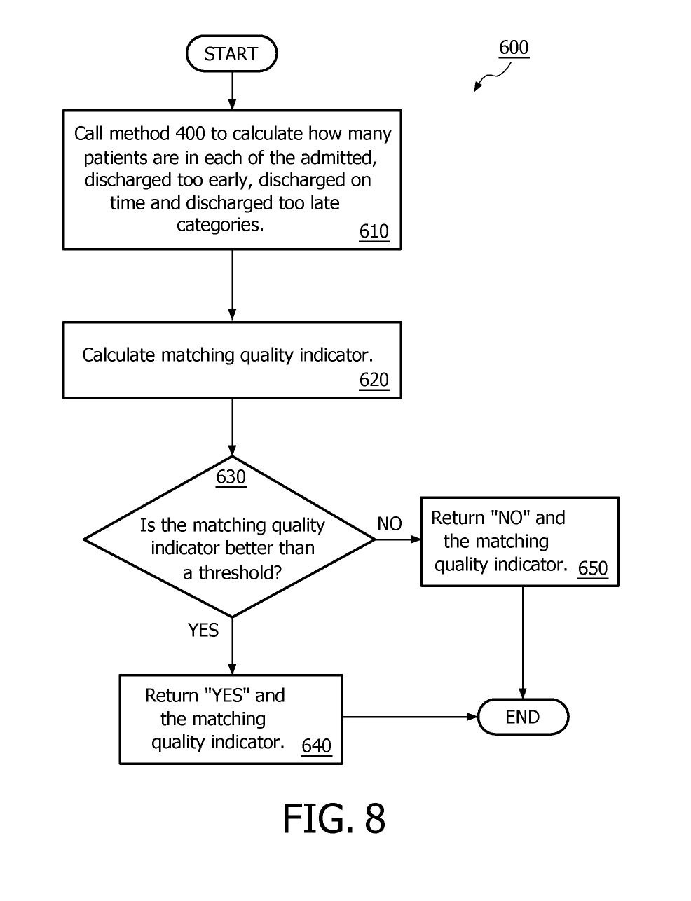

FIG. 8 shows a flow diagram of a method for measuring a level of matching between a current set of discharge criteria and current clinical practices according to an exemplary embodiment.

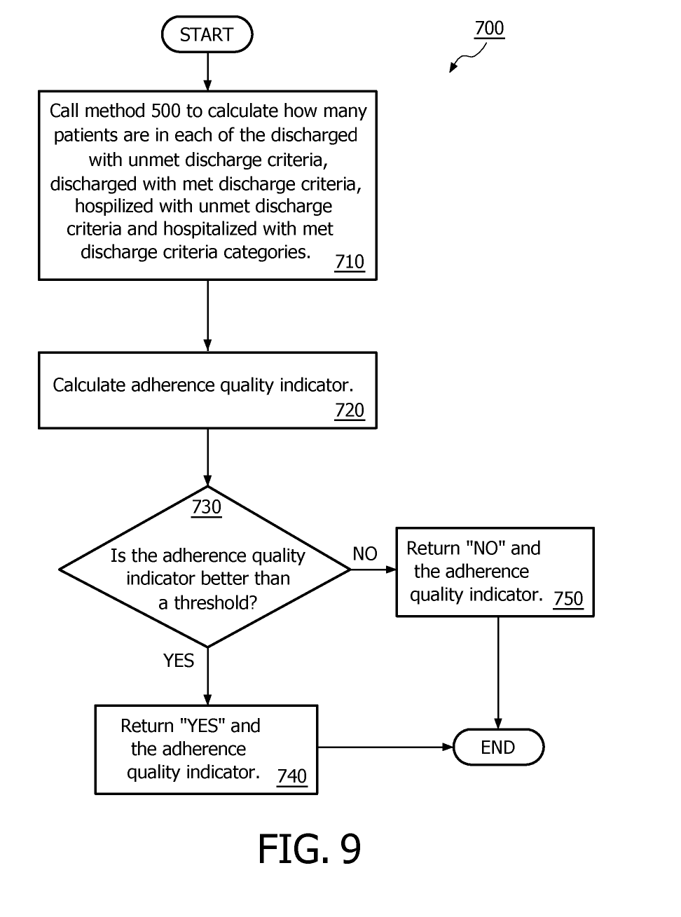

FIG. 9 shows a flow diagram of a method for measuring a level of a user adherence to a set of discharge criteria according to an exemplary embodiment.

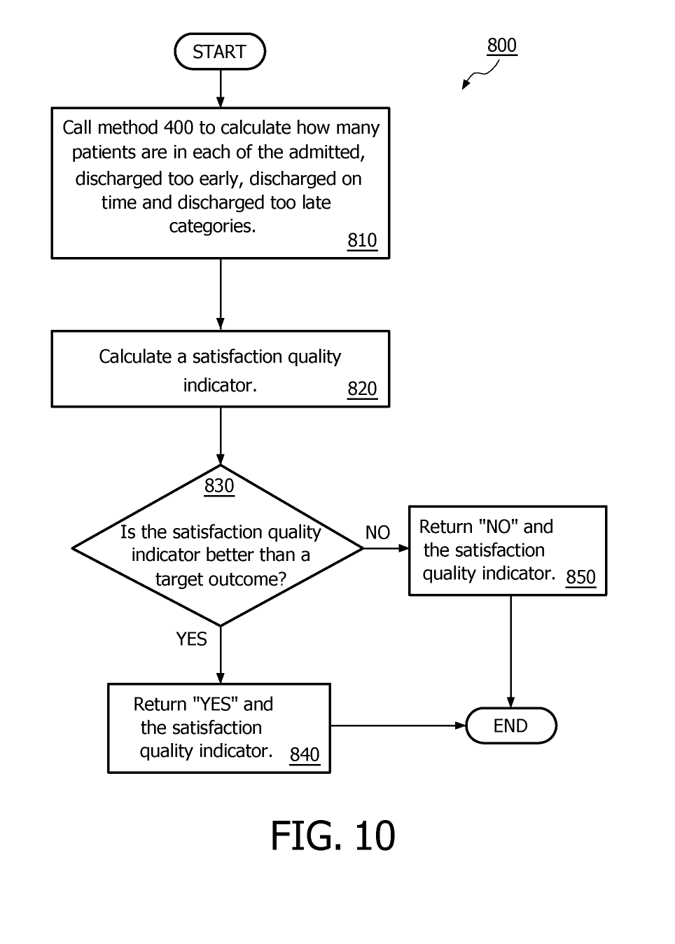

FIG. 10 shows a flow diagram of a method for measuring a level at which a set of discharge criteria satisfies a target outcome according to an exemplary embodiment.

The exemplary embodiments may be further understood with reference to the following description and the appended drawings wherein like elements are referred to with the same reference numerals. The exemplary embodiments relate to a system and method for quality evaluation and improvement of discharge planning for a patient population. In particular, the exemplary embodiments provide a system and method for evaluating discharge criteria for a particular patient population within a hospital department against target outcomes. In addition, the exemplary embodiments provide population distribution information regarding the discharge of patients within the population such that a user may determine a quality of the discharge criteria to identify any necessary improvements. Although the exemplary embodiments are specifically described in regard to patients having acute decompensated heart failure (ADHF) within a cardiology department, it will be understood by those of skill in the art that the system and method of the present disclosure may be used for patients having any of a variety of diseases or conditions within any of a variety of hospital departments.

As shown in FIG. 1, a discharge planning improvement system 100 according to an exemplary embodiment of the present disclosure evaluates discharge criteria for a particular patient population within a hospital department against target outcomes and determines a population distribution of patients based on the discharge criteria to assess the quality of the discharge criteria. For example, the exemplary embodiments may evaluate the quality of discharge criteria for heart failure patients within the cardiology department of a hospital. The system 100 comprises a processor 102, a user interface 104, a display 106 and a memory 108. The memory 108 stores a set of discharge criteria 120 that is used by the processor 102 to determine a patient's readiness for discharge. The memory 108 also includes a population database 112 comprised of a plurality of patient records 110 for all current and previous patients within the population (e.g. all ADHF patients). The patient records 110 may include data such as patient identification (e.g., name, age, gender), factors associated with biophysical health (e.g., reason for admission, vitals, test results, medical history and co-morbidities), as well as treatments used and the patient's response to the treatments. The set of discharge criteria 120 may be specific to the patient's disease or condition, or may also include general criteria that are applicable to most or all patients. The set of discharge criteria 120 for a patient suffering from ADHF may include criteria established by medical institutions such as, for example, the Heart Failure Society of America. The set of discharge criteria 120 may include, for example, whether exacerbating factors have been addressed, whether near optimal pharmacological therapy has been achieved, whether the patient's oral medication regimen has been stable for 24 hours, etc. It will be understood by those of skill in the art, however, that the set of discharge criteria 120 may include any set of criteria accepted in the medical field.

The processor 102 assesses a patient's readiness for discharge by calculating a discharge score based on the set of discharge criteria 120 to produce a discharge recommendation 124 which indicates to a physician or other user whether the patient should be discharged. The processor 102 calculates the discharge score by running, for example, an Evaluations Manager program 114 for evaluating the patient record 110 and determining whether the discharge criteria 120 are satisfied, a Predictions Manager 116 for predicting future results based on the population database 112 and a Decisions Manager program 118 for generating recommendations for discharge and/or treatment options. The discharge score and/or recommendations 124 may, for example, be determined as described in U.S. Application No. 61/439,586 filed on Feb. 4, 2011 and entitled “Clinical Decision Support System for Predictive Discharge Planning,” the entire disclosure of which is incorporated herein by reference. The discharge score and/or recommendations 124 are saved to the corresponding patient record 110 in the memory 108. Additional discharge-related information may also be saved to the patient records 110 in the memory 108 such as, for example, whether the patient is actually discharged, when the patient is discharged, and whether the patient is subsequently readmitted. The processor 102 further executes a Quality Manager program 122 which evaluates the set of discharge criteria 120 based on the discharge recommendations 124 by determining whether they match current clinical practices, whether physicians adhere to the discharge criteria 120 and whether the discharge criteria 120 satisfy a target outcome. The user may input instructions and/or tasks associated with the Evaluations Manager 114, the Predictions Manager 116, the Decisions Manager 118 and the Quality Manager 122 via the user interface 104. The user may also indicate preferences or selections via the user interface 104, which may include input devices such as, for example, a keyboard, mouse and/or touch display on the display 106. Discharge recommendations 124 and/or quality assessments generated from the processed data are displayed on the display 106.

FIG. 2 shows a method 200 by which the Quality Manager 122 determines whether a target outcome is being achieved using the set of discharge criteria 120. The method 200 may be used to determine which components of the current discharge planning program (e.g., discharge criteria) require quality improvement. In a step 210, the user selects an outcome to test and inputs the selected outcome using the user interface 104. The user also sets a target outcome. For example, the user may elect to test the outcome of 30 days post-discharge readmission rates of ADHF patients using the current discharge criteria 120. The target rate of the 30 day readmission rates may be set at 20%. In a step 220, the Quality Manager 122 determines whether the current value of the outcome to test is better than the target outcome. The current value of the outcome (e.g., readmission rates) is determined from the patient records 110 of the population database 112. If, for example, the current value of readmission rates is determined to be 20% or more, the Quality Manager 122 will determine that the current outcome is not better than the target outcome of 20%. If, for example, the current value of readmission rates is determined to be less than 20%, the Quality Manager 122 will determine that the current outcome is better than the target outcome.

If the current outcome is better than the target outcome, the method 200 may end, as there is no need for quality improvements. If, however, the current outcome is not better than the target outcome, the method 200 proceeds to step 230, which calculates for each component of the discharge planning process that impacts the current outcome whether or not the target outcome is achieved, a quality indicator, which will be described in further detail below in regard to the methods 300 and 600-800. Components of the discharge planning process may include, for example, discharge criteria from the set of discharge criteria 120. Although the exemplary embodiment specifically describes the selected outcome as a 30 day post-discharge readmission rate, it will be understood by those of skill in the art that other outcomes such as, for example, a length of stay, may also be assessed. In another exemplary embodiment, the components of the discharge planning may include discharge instructions, which may also be saved on the memory 108. The quality indicator for each of the components (e.g., discharge criteria) is calculated using the methods described below.

FIG. 3 shows a method 300 by which the Quality Manager 122 evaluating the quality of a set of components currently used and indicates a need for quality improvement by calculating a number of quality indicators. Although the method 300 is specifically described in regard to discharge criteria, it will be understood by those of skill in the art that other components of the discharge planning process may also be evaluated. As discussed above, the processor 102 determines discharge recommendations 124 for patients by using a current set of discharge criteria 120, which may include criteria accepted within the medical field. In a step 310, the Quality Manager 122 determines whether the current set of discharge criteria 120 matches the current clinical practices by comparing discharge recommendations 124 stored in the patient records 110 with a discharge decision of a physician (e.g., cardiologist). If the discharge recommendation 124 does not match the current clinical practices, the method 300 proceeds to a step 320. If the discharge recommendation 124 matches the current clinical practices, the method 300 proceeds to a step 330.

In the step 320, the user is prompted to enter new discharge criteria and/or modify existing criteria via the user interface 104, updating the set of discharge criteria 120 to correspond to the current clinical practices. The user may, for example, enter a missing rule which overrides one of the existing rules in the current set of discharge criteria 120. For example, the physician may implicitly follow rules, “patients without social support are not discharged on Fridays” or “patients with home telehealth services can be discharged when health parameters are close to normal range.” The method 300 may also return a match quality indicator which indicates a level of matching between the current set of discharge criteria 120 and the current clinical practices prior to the modification of the discharge criteria. Once the set of discharge criteria 120 has been updated to correspond to the current clinical practices, the method 300 may return to the step 310 to reassess whether the set of discharge criteria 120 matches the current clinical practices.

If, however, the physician's decision to discharge corresponds with the discharge recommendation 124 (e.g., the discharge recommendation 124 indicates that the patient should be discharged and the physician correspondingly decides to discharge the patient), then the processor 102 indicates that the current set of discharge criteria 120 matches the current clinical practices, in the step 330, and returns a matching quality indicator indicating the level of matching between the current set of discharge criteria 120 and the current clinical practices. Calculation of the matching quality indicator described in steps 320 and 330 will be described in further detail below, in regard to a method 600.

The method 300 then proceeds to a step 340 in which the processor 102 determines how well physicians adhere to the updated set of discharge criteria 120, which corresponds to the current clinical practices, based on targets set for the complete set of discharge criteria 120 or for each individual discharge criterion. The processor 102 evaluates how well physician's adhere to discharge recommendations 124 generated based on the updated discharge criteria 120. If the processor 102 determines that the physician does not adhere to the discharge criteria 120 including the current clinical practices, the method 300 proceeds to a step 350. In the step 350, the method 300 indicates the need for operational improvements by, for example, providing an alert indicating to the physician that he is not adhering to the updated discharge criteria 120. For example, if physicians have discharged patients on Fridays despite the patient not having any social support, the processor 102 may provide an alert on the display 106 indicating to the physician that patients without social support have been incorrectly discharged.

The step 350 may also include more elaborate feedback to the physician or other user such as, for example, identifying individual discharge criterion of the discharge criteria 120 which are not being adhered to and analyzing root causes for non-adherence. Reasons for non-adherence may include, for example, time or resource constraints that made adherence impossible, error or negligence, incomplete or incorrect data available to physician/nurse at decision point, research/trial rules for enrolled patients and deliberate deviation or off-label therapy attempts. In the step 350, the processor 102 also returns an adherence quality indicator indicating a level of physician adherence to the updated discharge criteria 120. Once attempts to improve adherence have been made, the method 300 returns to the step 340 to reassess the physicians' adherence to the current clinical practices. If it is determined that physicians do adhere to the current clinical practices, the method 300 proceeds to a step 360 to return an adherence quality indicator indicating the level of physician adherence. The adherence quality indicator described above in steps 350 and 360 will be described in further detail below in regard to a method 700.

The method 300 then proceeds to a step 370 in which the processor 102 evaluates whether the updated discharge criteria 120, which corresponds to the current clinical practices, satisfy a target outcome such as, for example, a target 30 day readmission rate, as described above in regard to the method 200. If the current clinical practices do not satisfy the target outcome, the method 300 proceeds to a step 380. If the current clinical practices satisfy the target outcome, the method 300 proceeds to a step 390.

In the step 380, the processor 102 indicates the need for clinical improvements to bring discharge criteria 120 into alignment with target outcomes. The processor 102 may, for example, provide an alert to the physician indicating which criteria need improvement. The processor 102 also generates a satisfaction quality indicator for the updated discharge criteria 120 which indicates a level to which the updated discharge criteria 120 satisfies the target outcome. The step 380 may also include more elaborate feedback to the physician based on, for example, linear discriminate analysis (LDA), principal component analysis (PCA) and support vector machines (SVM) on clinical and cost outcomes as functions of the patient population. The analysis may identify new rules to be added to the current clinical practices, different thresholds for individual discharge criterion in the current clinical practices or adherence targets. Upon indication of the needs for clinical improvements, the method 300 returns to the step 370 to reassess whether the updated discharge criteria 120 satisfy target outcomes.

In the step 390, the method 300 returns a set of discharge criteria from the updated discharge criteria 120 that satisfy the target outcome and also returns a satisfaction quality indicator indicating the level of satisfaction. The satisfaction quality indicator described above in steps 380 and 390 will be described in further detail below in regard to a method 800.

The quality indicators described above—matching quality indicator, adherence quality indicator and satisfaction quality indicator—are quantification measurements which range in value between 0 and 1. The closer in value the quality indicators are to 1, the better the level of matching, adherence and satisfaction. As will be described in further detail below, a predetermined threshold value for each quality indicator may be used to determine whether the matching, adherence and satisfaction are good or poor.

FIG. 4 shows a method 400 by which the Quality Manager 122 evaluates a patient population distribution during a predetermined period of time. In particular, the method 400 categorizes the patient population into admission and discharges. Of those patients that have been discharged, the method 400 may further categorize the patients into three categories indicating whether the patient has been discharged too early, on time or too late. In a step 405, the processor 102 reviews each of the patient records 110 within the population database 112 to determine whether a patient has been admitted or discharged during a given period P (e.g., in a given month, week or quarter). For all admitted patients, the method proceeds to a step 410. In the step 410, the processor 102 assesses the number of admissions in the given period and for each additional admission, the processor 102 adds one to the total number of admissions. It will be understood by those of skill in the art that the step 410 may be repeated to account for all the admissions within the given period.

For all discharged patients, the method proceeds to a step 420. In the step 420, the processor 102 calculates a discharge score of the discharged patient on the day of discharge to determine a discharge recommendation 124. As described above in regard to the system 100, the discharge score is calculated based on whether each individual criterion of the discharge criteria 120 is met. For example, when the discharge criteria 120 are not met, the discharge score will indicate that the criteria have not been satisfied. When the discharge criteria 120 have been somewhat satisfied, the discharge score will indicate that the criteria have been somewhat satisfied. When the discharge criteria have all been met, the discharge score will indicate that the criteria have been satisfied. These scores may be color-coded to indicate the discharge recommendation 124. For example, a red score will indicate that a patient is not ready for discharge, a yellow score will indicate that a patient is close to being ready for discharge, and a green score will indicate that a patient is ready for discharge. Although the exemplary embodiment specifically describes the discharge scores and recommendations in terms of the color-codes, it will be understood by those of skill in the art that the results of the discharge score and/or discharge recommendation 124 may be displayed to the user in any of a variety of ways.

In steps 430-480, as will be described in further detail below, the processor 102 determines whether the discharge score becomes green on the same day that the patient is discharged to categorize the discharged patient into one of three categories: discharged on time (Dot), discharged too early (Dte) and discharged too late (Dtl). For example, as shown in FIG. 5, a discharge score that indicates that the patient is ready to be discharged for the first time on the same day that the patient is discharged (FIG. 5, DScore, Pattern 1) is categorized as discharged on time. In another example, the discharge score may be displayed as green. A discharge score that does not indicate that the patient is ready to be discharged (e.g., not ready for discharge, close to being ready for discharge) on the day that the patient is discharged (FIG. 5, DScore, Pattern 2) indicates that the patient has been discharged too early. In another example, the discharge score may be displayed as red (not ready for discharge) or yellow (close to being ready for discharge). A discharge score that indicates that the patient is ready for discharge prior to the day that the patient is discharged indicates that the patient was discharged too late (FIG. 5, DScore, Pattern 3).

In the step 430, the processor 102 determines whether the discharge score is, for example, green, indicating that all the discharge criteria have been met. If the discharge score is not green, then the method 400 proceeds to step 440. In the step 440, the processor 102 concludes that the patient has been discharged with unmet discharge criteria and increases the number of patients in the Dte category by one. If, in the step 430, the processor 102 determines that the discharge score is green, the method 400 proceeds to the step 450. In the step 450, the processor 102 calculates the first day that the discharge score was green for the patient. In the step 460, the processor 102 determines whether the first day that the discharge score was green is the same day that the patient was discharged. If the first day that the discharge score was green is the same day as the patient was discharged, the method 400 proceeds to the step 470, in which the processor concludes that the discharge criteria have been met and increases the number of patients in the Dot category by one. If the first day that the score was green is not the same day as that the patient was discharged, the method proceeds to the step 480. In the step 480, the processor concludes that the patient had not been discharged even though the discharge criteria were met earlier and increases the number of patients in the Dtl category by one. It will be understood by those of skill in the art that the steps 420-480 may be repeated until all of the discharged patients within the given period have been categorized into one of the three categories of discharged too early, discharged on time and discharged too late. In a step 490, the total number of admissions and discharged patients within the three categories may then be displayed to the user on the display 106.

FIG. 6 shows a method 500 by which the Quality Manager 122 determines a patient population distribution on a given day D by categorizing the patient population into one of four categories: discharged patients with met discharge criteria (DM), still hospitalized patients with unmet discharge criteria (HU), discharged patients with unmet discharge criteria (DU) and still hospitalized patients with met discharge criteria (HM). The method 500 may be particularly useful since many patients in the DU category have high readmission rates and the long lengths of stay of the patients in the HM category can indicate an opportunity for improvement. In a step 510, the processor 102 reviews the patient record 110 to calculate a discharge score and/or recommendation 124 of a patient and obtain a discharge status of the patient on the given day D. In a step 520, the processor 102 determined whether the discharge score is, for example, in the green range, indicating all of the discharge criteria 120 have been met. If not all of the discharge criteria have not been met, the method proceeds to a step 530. If all of the discharge criteria have been met, the method proceeds to a step 560.

In the step 530, the processor 102 determines whether the discharge status of the patient is discharged. If the patient has been discharged, the method 500 proceeds to a step 540 in which the processor 102 concludes that the patient has been discharged with unmet discharge criteria, increasing the number of patients in the DU category by one. If the patient has not been discharged, the method 500 proceeds to a step 550 in which the processor 102 concludes that the patient is still in the hospital with unmet discharge criteria, increasing the number of patients in the HU category by one.

In the step 560, the processor 102 determines whether the discharge status of the patient is discharged. If the patient has been discharged, the method 500 proceeds to a step 570 in which the processor 102 concludes that the patient has been discharged with met discharge criteria, increasing the number of patients in category DM by one. If the patient has not been discharged, the method 500 proceeds to a step 580, in which the processor 102 concludes that the patient is still in the hospital even though all the discharge criteria have been met, increasing the number of patients in the category HM by one.

It will be understood by those of skill in the art that each of the above steps may be repeated until all of the patients on the given day have been categorized into one of the four categories described above. Upon categorization of all of the patients on the given day in steps 540, 550, 570 and 580, the method proceeds to a step 590 in which the number of patients in each of the categories DM, DU, HU, HM, the total number of patients in the department on the given day (DM+DU+HU+HM), the total number of discharged patients on the given day (DM+DU) and/or the total number of hospitalized patients on the given day (HM+HU) may be displayed to the user on the display 106, as shown for example, in FIG. 7.

FIG. 8 shows a method 600 by which the Quality Manager 122 calculates a matching quality indicator which indicates a level of matching between the current set of discharge criteria 120 and the current clinical practices, as described above in regard to the method 300. The method 600 utilizes the method 400, as described above, which determines a patient population distribution during a given period P to determine the quality of the current set of discharge criteria. In a step 610, the processor 102 calls the method 400, inputting the current set of discharge criteria 120 (i.e., prior to updating with any current clinical practices) to calculate the number of admitted patients and discharged patients within each of the categories Dte, Dot and Dtl. In a step 620, the processor 102 calculates the matching quality indicator as a ratio of the number of patients discharged on time (Dot) to all the discharged patients (Dte+Dot+Dtl) in the given period P.

In a step 630, the processor 102 determines whether the calculated quality indicator is better than a predetermined threshold value. If the calculated quality indicator is greater than the threshold value, the method 600 proceeds to a step 640. If the calculated quality indicator is not better than the threshold value, the method 600 proceeds to a step 650. For example, the threshold value may be set at 0.8 such that any quality indicator values greater than 0.8 proceed to step 640 while any quality indicator values less than or equal to 0.8 proceed to the step 650. In the step 640, the processor 102 concludes that the current set of discharge criteria and the current clinical practices are a good match, returning, for example a “YES” and the calculated quality indicator, which may be displayed on the display 106. In the step 650, the processor 102 concludes that the current set of discharge criteria and the current clinical practices are a poor match, returning, for example, a “NO” and the calculated quality indicator, which may be displayed on the display 106. Although the method 600 specifically displays a “YES” and “NO” to indicate whether the current set of discharge criteria 120 and the current clinical practices are a good match, it will be understood by those of skill in the art that the same information may be conveyed and/or displayed in any of a number of different ways.

FIG. 9 shows a method 700 by which the Quality Manager 122 calculates an adherence quality indicator which measures a physician or other user's adherence to the updated discharge criteria 120, which has already been matched to the current clinical practices, as described above in regard to the method 300. The method 700 utilizes the method 500, as described above, which determines a patient population distribution on a given day D. In a step 710, the processor calls the method 500 and inputs the updated discharge criteria 120 to calculate the number of patients in each of the categories DM, DU, HU and HM described above. In a step 720, the processor 102 calculates the adherence quality indicator as a ratio of the number of patients who are in the categories DM and HU to all of the patients in the department (DM+DU+HU+HM). As will be understood by those of skill in the art, those patients that have been discharged with met criteria and those patients that remain hospitalized with unmet criteria indicate an adherence to the current clinical practices since only those patients who have met all of the discharge criteria should be discharged.

In a step 730, the processor 102 determines whether the calculated adherence quality indicator is better than a predetermined threshold value. If the adherence quality indicator is better than the threshold value, the method 700 proceeds to a step 740, in which the processor 102 returns, for example, a “YES” indicating that a physician adherence rate to the updated discharge criteria 120 is good. If the adherence quality indicator is not better than the threshold value, the method 700 proceeds to a step 750, in which the processor returns a “NO,” indicating that a physician adherence rate to the updated discharge criteria 120 is poor. The adherence quality indicator values and the adherence evaluation may be displayed on the display 106. It will be understood by those of skill in the art that although a “YES” and a “NO” are specifically described, the results of the adherence evaluation may be displayed on the display in any number of ways so long as the level of adherence is clearly conveyed to the user.

FIG. 10 shows a method 800 by which the Quality Manager 122 measures how well the updated discharge criteria 120, which has been matched to the current clinical practices, satisfies the target outcome, as described in method 300 above. The method 800 utilizes the method 400 which determines a patient population distribution within a department during a given period P. In a step 810, the processor 102 calls the method 400 and inputs the updated discharge criteria 120 to calculate the number of patients that have been admitted and discharged within the given period P. Those patients that have been discharged are categorized into the three categories of discharged too early (Dte), discharged on time (Dot) and discharged too late (Dtl). It should be noted that the step 810 is substantially similar to the step 610 of the method 600. Since, however, the step 810 inputs discharge criteria 120 corresponding to the current clinical practices rather than the current set of discharge criteria which does not include current clinical practices, the number of patients that have been discharged too early and/or discharged too late should be minimized as compared to those calculated in the method 600.

In a step 820, the processor 102 calculates a satisfaction quality indicator which measures a selected outcome (e.g., readmission rate, length of stay) within one of the output categories described in the step 810. For example, the satisfaction quality indicator may measure a 30 day post-discharge readmission rate for those patients that were discharged on time. In another example, the satisfaction quality indicator may measure a length of stay for patients in the admitted category. In a step 830, the processor 102 determines whether the calculated satisfaction quality indicator is better than a target outcome. If the satisfaction quality indicator is better than the target outcome, the method 800 proceeds to a step 840. If the satisfaction quality indicator is not better than the target outcome, the method 800 proceeds to a step 850. For example, if the target readmission rate is designated as 20%, a value of less than 20% will indicate that the satisfaction quality indicator is better than the target outcome such that the method 800 proceeds to the step 840. If the value is, for example, 20% or more, the method 800 will proceed to the step 850.

In the step 840, the processor 102 concludes that the current clinical practices satisfy the target outcome and return a “YES” along with the calculated satisfaction quality indicator, which may be displayed on the display 106. In the step 850, the processor 102 concludes that the current clinical practices do not satisfy the target outcome and returns a “NO” along with the calculated satisfaction quality indicator, which may be displayed on the display 106. Although the exemplary embodiment specifically describes displaying a “YES” or a “NO” it will be understood by those of skill in the art that the evaluation of whether the discharge criteria 120 satisfies the target outcome may be displayed to the user in any of a variety of different ways so long as the results of the evaluation are clear to the user.

It is noted that the claims may include reference signs/numerals in accordance with PCT Rule 6.2(b). However, the present claims should not be considered to be limited to the exemplary embodiments corresponding to the reference signs/numerals.

Those skilled in the art will understand that the above-described exemplary embodiments may be implemented in any number of manners, including, as a separate software module, as a combination of hardware and software, etc. For example, the Evaluations Manager 114, Prediction Manager 116, Decisions Manager 118 and Quality Manager 122 may be programs containing lines of code that, when compiled, may be executed on a processor.

It will be apparent to those skilled in the art that various modifications may be made to the disclosed exemplary embodiments and method and alternatives without departing form the spirit or scope of the disclosure. Thus, it is intended that the present disclosure cover modifications and variations provided that they come within the scope of the appended claims and their equivalents.

1. A method for evaluating a discharge planning process, comprising:
determining whether a current set of discharge criteria matches current clinical practices;
generating a matched set of discharge criteria by adapting the current set of discharge criteria to reflect the current clinical practices;
generating a matching quality indicator value indicating a level of matching between the current set of discharge criteria and the current clinical practices;
determining whether a user adheres to the matched set of discharge criteria;
generating an adherence quality indicator value indicating a level to which the user adheres to the matched set of discharge criteria;
determining whether the matched set of discharge criteria satisfies a target outcome; and
generating a satisfaction quality indicator value indicating a level to which the matched set of discharge criteria satisfies the target outcome.

2. The method of claim 1, wherein determining whether the matched set of discharge criteria satisfies the target outcome includes comparing a current outcome generated from patient records within a patient population database to the target outcome.

3. The method of claim 1, further comprising:
determining a number of patients that have been admitted and a number of patients that have been discharged during a selected period;
generating a discharge score for each discharged patient which indicates whether one of the current and the matched set of discharge criteria have been met; and
categorizing each discharged patient as one of discharged too early, discharged on time and discharged too late based on the discharge score.

4. The method of claim 1, further comprising:
generating a discharge score for each patient on a selected day which indicates whether one of the current and the matched set of discharge criteria have been met;
identifying a discharge status of each patient on the selected day; and
categorizing each of the patients as one of discharged with unmet discharge criteria, hospitalized with unmet discharge criteria, discharged with met discharge criteria and hospitalized with met discharge criteria.

5. The method of claim 3, wherein the matching quality indicator value is a ratio of a number of patients in the discharged on time category to a total number of discharged patients during the selected period.

6. The method of claim 5, wherein determining whether the current set of discharge criteria matches the current clinical practices by comparing the matching quality indicator value to a predetermined matching threshold value.

7. The method of claim 4, wherein the adherence quality indicator is a ratio of a number of patients in the discharged with met discharge criteria and hospitalized with unmet discharge criteria categories to a total number of patients on the selected day.

8. The method of claim 7, wherein determining whether the user adheres to the matched discharge criteria includes comparing the adherence quality indicator value to a predetermined adherence threshold value.

9. The method of claim 3, wherein the satisfaction quality indicator value is a value of a selected outcome within at least one of the admitted category, discharged too early category, discharged on time category, discharged too late category and a combined total patient population.

10. The method of claim 9, wherein determining the satisfaction of the matched discharge criteria includes comparing the value of the selected outcome to a predetermined satisfaction threshold value.

11. The method of claim 1, wherein generating the matched set of discharge criteria includes identifying a need for clinical improvement, deriving potential new riles from analysis of clinical and cost outcomes correlated with patient data, and proposing new rules to be added to the discharge criteria.

12. A system for evaluating a quality of a threshold process, comprising:
a memory storing a current set of discharge criteria; and
a processor determining whether the current set of discharge criteria matches current clinical practices, generating a matched set of discharge criteria by matching the current set of discharge criteria to reflect the current clinical practices, generating a matching quality indicator value indicating a level of matching between the current set of discharge criteria and the current clinical practices, determining whether a user adheres to the matched set of discharge criteria, generating an adherence quality indicator value indicating a level to which the user adheres to the matched set of discharge criteria, determining whether the matched set of discharge criteria satisfies a target outcome, and generating a satisfaction quality indicator value indicating a level to which the matched set of discharge criteria satisfies the target outcome, using the processor.

13. The system of claim 12, wherein the memory stores a plurality of patient records within a patient database and the processor compares a current outcome generated from patient records to a target outcome to determine whether discharge criteria are satisfied.

14. The system of claim 12, wherein the processor determines a number of patients that have been admitted and a number of patients that have been discharged during a selected period, generates a discharge score for each discharged patient which indicates whether one of the current and the matched set of discharge criteria have been met, and categorizes each discharged patient as one of discharged too early, discharged on time and discharged too late based on the discharge score.

15. The system of claim 12, wherein the processor generates a discharge score for each patient on a selected day which indicates whether one of the current and the matched set of discharge criteria have been met, identifies a discharge status of each patient on the selected day, and categorizes each of the patient as one of discharged with unmet discharge criteria, hospitalized with unmet discharge criteria, discharged with met discharge criteria and hospitalized with met discharge criteria.

16. The system of claim 14, wherein the matching quality indicator value is a ratio of a number of patients in the discharged on time category to a total number of discharged patients during the selected period.

17. The system of claim 16, wherein the processor determines whether the current set of discharge criteria matches the current clinical practices by comparing the matching quality indicator value to a predetermined matching threshold value.

18. The system of claim 15, wherein the adherence quality indicator is a ratio of a number of patients in the discharged with met discharge criteria and hospitalized with unmet discharge criteria categories to a total number of patients on the selected day.

19. The system of claim 18, wherein the processor determines whether the user adheres to the matched discharge criteria includes comparing the adherence quality indicator value to a predetermined adherence threshold value.

20. The system of claim 14, wherein the satisfaction quality indicator value is a value of a selected outcome within at least one of the admitted category, discharged too early category, discharged on time category, discharged too late category and a combined total population.

21. The system of claim 20, wherein the processor determines the satisfaction of the matched discharge criteria includes comparing the value of the selected outcome to a predetermined satisfaction threshold value.

22. The system of claim 12, wherein the processor generates the matched set of discharge criteria by identifying a need for clinical improvement, deriving potential new riles from analysis of clinical and cost outcomes correlated with patient data and proposing new rules to be added to the discharge criteria.
